(19) United States
(12) Patent Application Publication
(10) Pub. No.: US 2019/0244400 A1
(43) Pub. Date: Aug. 8, 2019

(54) System And Method For Generating Digital Road Models From Aerial Or Satellite Images And From Data Captured By Vehicles

(71) Applicant: CONTINENTAL AUTOMOTIVE GmbH, Hannover (DE)

(72) Inventors: Henning HAMER, München (DE); Steen KRISTENSEN, Lindenberg im Allgaü (DE)

(21) Appl. No.: 16/342,863

(22) PCT Filed: Oct. 17, 2017
(86) PCT No.: PCT/EP2017/076503

§ 371 Date: Apr. 17, 2019

(30) Foreign Application Priority Data
Oct. 18, 2016 (DE) 10 2016 220 308.8

(51) Int. Cl. G06T 11/20; G01C 21/32; G06K 9/00

(52) U.S. Cl. CPC G06T 11/203; G06K 9/00791; G06K 9/00651; G01C 21/32

(57) ABSTRACT

A method for creating a digital road model for at least one road section includes: receiving and storing at least one trajectory of a vehicle for the at least one road section; receiving at least one image showing at least parts of the road section, the image having a perspective corresponding to an image recorded vertically downward from an elevated position; superimposing the at least one image on the at least one trajectory to correspond the trajectory to the course of a road in the at least one image; analyzing the at least one image in a corridor extending along and enclosing the trajectory to identify driving-relevant or positioning-relevant features of the road section in the corridor; and generating the digital road model from the identified features, aligned on the basis of the at least one trajectory and in the corridor enclosing the trajectory.

### CROSS REFERENCE TO RELATED APPLICATIONS

This is a U.S. national stage of application No. PCT/EP2017/076503, filed on Oct. 17, 2017, which claims priority to German Application No. 10 2016 220 308.8, filed Oct. 18, 2016, the content of each of which is incorporated herein by reference.

### BACKGROUND OF THE INVENTION

### 1. Field of the Invention

The present invention relates to the generation of digital road models using a combination of aerial or satellite images, which represent a substantially vertical plan view of a part of a landscape from a bird's-eye view, and data captured by vehicles when driving on roads, for example camera images or data from scanning sensors, that is to say radar, lidar, ultrasound and the like.

### 2. Description of the Prior Art

Digital road models are required for many intended purposes in the field of mobility, for example for navigation systems, driver assistance systems, autonomously driving vehicles. For driver assistance systems and autonomously driving vehicles in particular, a generally high degree of accuracy and the largest possible number of distinctive features on or along the road are necessary in the digital road models in order to enable position determination which is more accurate than known positioning methods such as satellite navigation or dead reckoning methods.

In order to capture and update the data on which the road models are based, providers of digital road models have special vehicles equipped with a number of different sensors drive on the roads. Since the number of vehicles used for these purposes is small, updating of the road data may require a relatively long time. In addition, the position data relating to the vehicles are often inaccurate on account of the inaccuracy of the positioning sensors, thus resulting overall in an inaccurate digital road model.

The generation of a digital road model from aerial or satellite images requires individual images to be joined together. Whereas images can be joined together in the case of sufficient image resolution and overlap, this appears to be possible only to a limited extent in the event of gaps in the capture; in any case, discontinuities may arise at the connections and reduce the accuracy of the overall model. Distortions caused by the optical systems used, in particular at the edges of an image, and different resolutions in the case of images from different sources also make it difficult to join together aerial or satellite images in a highly accurate manner. Finally, a complicated search for roads and routes in the composed images must also be carried out without rivers or canals being incorrectly identified as roads and without roads which are concealed by trees being overlooked.

### SUMMARY OF THE INVENTION

An object of the invention is to specify a system and a method which enable generation and prompt updating of highly accurate digital road models.

### Explanations of Terms

In the context of this description, a trajectory corresponds to a series of waypoints at which a vehicle was actually on a roadway or road at a time. Each waypoint can be explicitly determined for example by relative coordinates, e.g., represented by a vector describing a distance and a direction of the respective waypoint with respect to a roadside or a marking on or at the roadway or road, or to another explicitly locatable reference point. For example an imaging sensor of the vehicle can be used for this type of position determination, for example a camera or a scanning lidar system. Road markings can be detected e.g., by detecting color differences between the road surface and the marking, or by detecting different surface structures. The description of the detected markings can be provided by appropriate features or parameters suitable for relative positioning. However, determination of waypoints on a first trajectory can also be effected by determining absolute coordinates, such as those provided by a satellite navigation system, for example. Other systems and methods for determining a position can likewise be used, for example position determination by recording acceleration and deceleration over time, sensing the steering angle, speed, or combinations of different methods for increasing accuracy. Non-continuous recording of the waypoints can result in a trajectory being approximated by connecting the waypoints, for example by curves or spline-like lines following a polynomial function. A first trajectory can have a beginning and an end; however, a certain length is not mandatory.

In the context of this description, driving-relevant or positioning-relevant features of a road comprise, inter alia, road markings, noticeable geometries of roads or lanes, positions of curbs, manhole covers, streetcar rails and railroad tracks, etc. If nothing else emerges from the context, the term “driving-relevant” is interchangeable in this case with the term “positioning-relevant” because features of the road which are relevant to driving can usually also be used to determine the position of a vehicle and vice versa.

In addition to a database for retrievably storing trajectories and images, a system according to the invention for the generation and prompt updating of highly accurate digital road models comprises a first module for receiving at least one trajectory of a vehicle for the at least one road section and for storing the at least one trajectory in the database. A second module of the system is configured to receive at least one image that shows at least parts of the at least one road section, wherein the image has a perspective that corresponds to an image recorded from an elevated position substantially vertically downward, and to store the at least one image in the database. The modules for receiving trajectories or images can comprise one or more digital data interfaces having transmitters and/or receivers configured to be compatible with one or more telecommunication standards and are communicatively connected to other components of the system.

A third module of the system is configured to superimpose the at least one image on the at least one trajectory such that the at least one trajectory corresponds to the course of a road in the at least one image. The system also comprises a fourth module for analyzing the at least one image in a corridor that extends along the trajectory and encloses the trajectory and for identifying driving-relevant or positioning-relevant features of the road section in the corridor, and a fifth module for generating the digital road model from the driving-relevant or positioning-relevant features that have been identified in the at least one image aligned on the basis of the at least one trajectory and in the corridor enclosing the trajectory.

A fifth module of the system is configured to generate the digital road model from the driving-relevant or positioning-relevant features that have been identified in the at least one image aligned on the basis of the at least one trajectory and in the corridor enclosing the trajectory.

At least two modules of the system are communicatively connected to one another via corresponding physical or logical interfaces and/or bus systems for the purpose of interchanging data. One or more of the modules of the system may comprise one or more computers that execute a corresponding computer program which implements that part of the method according to the invention for creating a digital road model for at least one road section which is performed by the respective module. However, one or more of the modules of the system may also be implemented as corresponding computer programs, a plurality of which are executed in a computer and interact in order to perform at least parts of the method according to the invention.

The system can also be regarded as being formed from one or more function blocks as in a functional module architecture. In this instance, respective function blocks represent structure for performing applicable functions. As explained for the modules, the structure can be implemented by one or more computers or data processing units configured by a computer program for performing applicable functions.

The one or more computers of the system can comprise one or more microprocessors communicatively connected to the main memory and/or nonvolatile storage and other system components via one or more data buses that receive and/or send data before and/or during the execution of computer program instructions, as a result of which the computers or processing units perform at least parts of the method. The nonvolatile storage comprise different storage media, e.g., optical or magnetic memories, phase change or flash memories. Multiple modules or function blocks can be implemented in a computer or a data processing unit.

The computer program or the computer program instructions which implement(s) respective parts of the method according to the invention can be stored on one or more data storage media or in storage. The computer program instructions can be transferred to the storage by using interfaces connected wirelessly or by cables or lines. The computer program instructions are available outside the system as a computer program product that is permanently stored on a computer-readable medium or machine-readable medium and that can be regarded as a computer program stored on a carrier medium.

The computer program product can also be available in a non-permanent, temporary form, e.g., as an electromagnetic or optical signal temporarily representing the computer program instructions by means of its modulation. The modulation therefore imparts the computer program instructions to the signal in a temporarily readable form, for example during transfer of the computer program instructions from a data storage medium to the system. In this case, the signal, e.g., represented by a modulated carrier, is a specific embodiment of the computer program product from which it can be taken or tapped off.

A method according to one aspect of the invention for creating a digital road model for at least one road section, which is carried out in a database outside the vehicle, comprises receiving at least one trajectory of a vehicle for the at least one road section. If a plurality of trajectories are received from a multiplicity of vehicles for the same road section for the same lane and for the same direction of travel, they can be combined to form a single trajectory using statistical methods before the resulting trajectory is used for the purposes of the method. Suitable statistical methods comprise, inter alia, the formation of a median trajectory which is formed from position values of a multiplicity of trajectories, which are transverse with respect to a direction of travel, for corresponding positions in a longitudinal direction along the road section.

In addition, at least one image that shows at least parts of the road section in which the trajectory lies is received, wherein the image has a perspective that corresponds to an image recorded from an elevated position substantially vertically downward. Such an image may be, for example, an aerial image or a satellite image or generally an image that corresponds to a plan view from above. If an image does not have a perspective that corresponds to a substantially vertical view downward, an image recorded obliquely downward can also be converted into an image that has the desired perspective by using appropriate transformations.

The at least one image is superimposed on the at least one trajectory such that the at least one trajectory corresponds to the course of a road in the at least one image. To make the trajectory and the course of a road correspond, it is also possible to extend or compress the images or the trajectory in one or two dimensions in addition to shifting or rotating the images or the trajectory. If a trajectory extends over a plurality of images that adjoin one another or partially overlap, each of these images can each be separately superimposed on the trajectory and the images can then be aligned with one another on the basis of the trajectory, thus resulting in an overall image composed of individual images after superimposition has been carried out. If a trajectory extends over a plurality of images which do not have a common edge or an overlap, the corresponding region in the overall image can remain free.

The at least one image or the overall image is subjected to an image analysis that identifies driving-relevant features of the at least one road section. In this case, the analysis is carried out only in a region of the image that extends over a first distance along the trajectory on one or both sides transversely with respect to the trajectory, that is to say virtually places a corridor or an envelope around the trajectory. Identified driving-relevant or positioning-relevant features in adjoining or overlapping image regions can be used to align the images even more accurately with one another, for example continuous road markings, side lines, curb edges or guardrails.

The digital road model is finally generated from the driving-relevant or positioning-relevant features of the road section that have been identified in the at least one image aligned on the basis of the at least one trajectory and in the corridor enclosing the trajectory. The digital road model may be present in different forms, for example as a vector model, in which the road edges and other features that can be used when determining the position of a vehicle are stored as objects in a vector representation with their relative positions with respect to one another. For this purpose, the individual objects may have one or more reference points, the distance and angle of which with respect to other objects are determined, and/or the absolute positions of which on the Earth's surface are known.

An elevation component of the digital road model, also referred to as the Z component or relief component, can be extracted, in one aspect of the present method, from data relating to the at least one trajectory, from a topography database or from a digital elevation model.

According to one aspect of the present method, information relating to driving-relevant or positioning-relevant features of the road section that have been captured by the vehicle is received in addition to the at least one trajectory. The information may be transmitted, for example, as images from a camera or a scanning sensor, for example radar, lidar or ultrasonic sensors. The features comprise,

for example, markings on the road, boundary posts, traffic signs or other comparable features that change only slowly or do not change. The information or the features is/are provided with information relating to respective capture locations or positions, with the result that the received information or features can be used to align the received images or can be adopted into the digital road model. The received information relating to driving-relevant or positioning-relevant features of the road section can be used, for example in the case of adjoining images, to align these images more accurately with one another, for example if a feature is entirely or partially identifiable in both images.

In one exemplary embodiment of the aspect explained above, the additionally received information is received in an object-describing vector format. In this exemplary embodiment, the vehicle evaluates the sensor data and generates vector models of features from driving-relevant features and optionally determines at least one reference point for each vector model. The information received in the object-describing vector format may likewise be used for alignment with the received images or can be adopted into the digital road model. If, for example, a digital road model of a road section already exists and new information relating to features is received in an object-describing vector format, the features represented in the object-describing vector format can be aligned with less computing effort than would be possible with another representation. If information relating to a plurality of features present in such a format, including their relative positioning with respect to one another, has been received, an inaccuracy in the positioning used during capture can be compensated for by aligning the vector models with the digital road model.

In one aspect of the method, a digital road model generated according to the invention is transmitted, for example as a vector model, to vehicles whose trajectories have been received. If the respective vehicle is suitably equipped with sensors and computers suitable for evaluating images, information relating to features of the road section which is present in the object-describing vector format can be used to improve the accuracy when determining the vehicle position.

This accordingly improves the accuracy of the trajectory. As a result, it becomes possible to further restrict a region to be analyzed according to the invention, for example to one lane of a multilane road, and to carry out a more accurate analysis in the restricted region.

The present method and the corresponding system simplify the identification and extraction of roads and road features in satellite and aerial images and reduce the susceptibility to errors. The alignment and the composition of aerial or satellite images with one another are also simplified, for example if a trajectory extends over a plurality of adjoining or overlapping images. In this case, it is possible to dispense with the use of distinctive points on a route, as are used by vehicles when determining their position by triangulation, for example. The distinctive points used by the vehicles, also referred to as landmarks, are usually indicated from a perspective that can be assumed by a vehicle, whereas aerial or satellite images generally provide a completely different view of landmarks. Even if the representation of landmarks can be fundamentally converted into another perspective, inaccuracies may arise in this case. In contrast, a vehicle trajectory is sufficiently accurate per se, at least in pieces, generally does not have any discontinuities and is also already in a plane, with the result that alignment of aerial or satellite images requires fewer transformations. Since the vehicle trajectory is initially used only to determine a corridor within which the aerial images are then analyzed, the initially required accuracy is also not particularly high. In addition, if necessary, a general trajectory can be determined from a multiplicity of vehicles trajectories for the same route section and is then used to determine the analysis corridor. The superimposition of the trajectory also results in success sooner when only parts of the trajectory can be made to correspond to roads which can be identified in an aerial or satellite image, for example if a road in the aerial or satellite image is concealed by trees in pieces or partially and thus cannot be immediately identified as a road. A detailed analysis can nevertheless be carried out within the corridor around the trajectory in order to identify partially visible features.

### BRIEF DESCRIPTION OF THE DRAWINGS

Aspects of the invention will be described below with reference to the drawings. In the drawings:

FIG. 1 shows a first exemplary illustration of an aerial image and a trajectory;

FIG. 2 shows an illustration of the aerial image from FIG. 1, in which the trajectory has been made to correspond to a road which can be identified in the aerial image;

FIG. 3 shows an exemplary illustration of a corridor around the trajectory, within which a search is carried out for features of the road;

FIG. 4 shows a part of the corridor from FIG. 3 in an enlarged image section;

FIG. 5 shows an exemplary block diagram of a system according to an aspect of the invention,

FIG. 6 shows an exemplary block diagram of a module of the system according to an aspect of the invention; and

FIG. 7 shows a simplified exemplary flowchart of a method according to an embodiment of the invention.

### DETAILED DESCRIPTION OF THE PRESENTLY PREFERRED EMBODIMENTS

In the figures, identical or similar elements are denoted by the same reference signs.

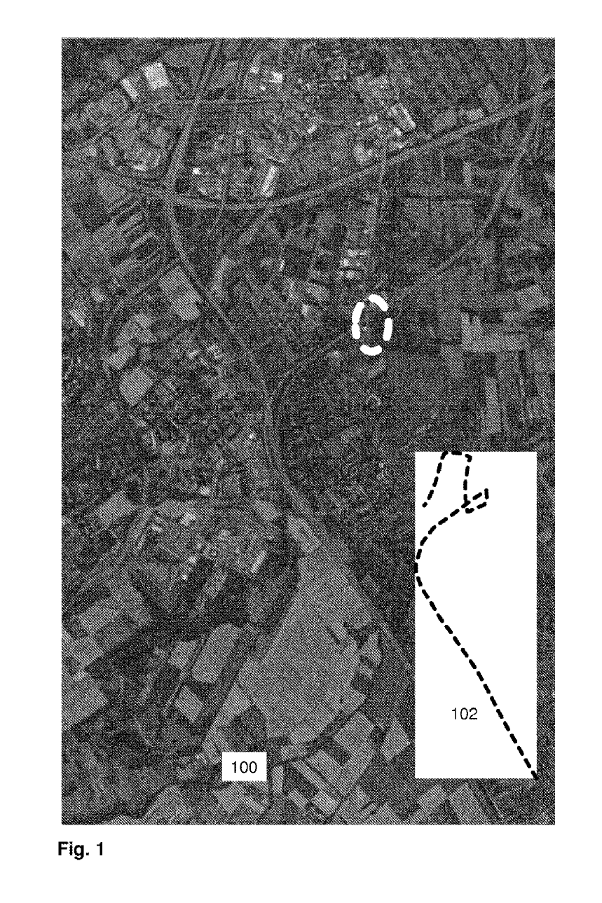

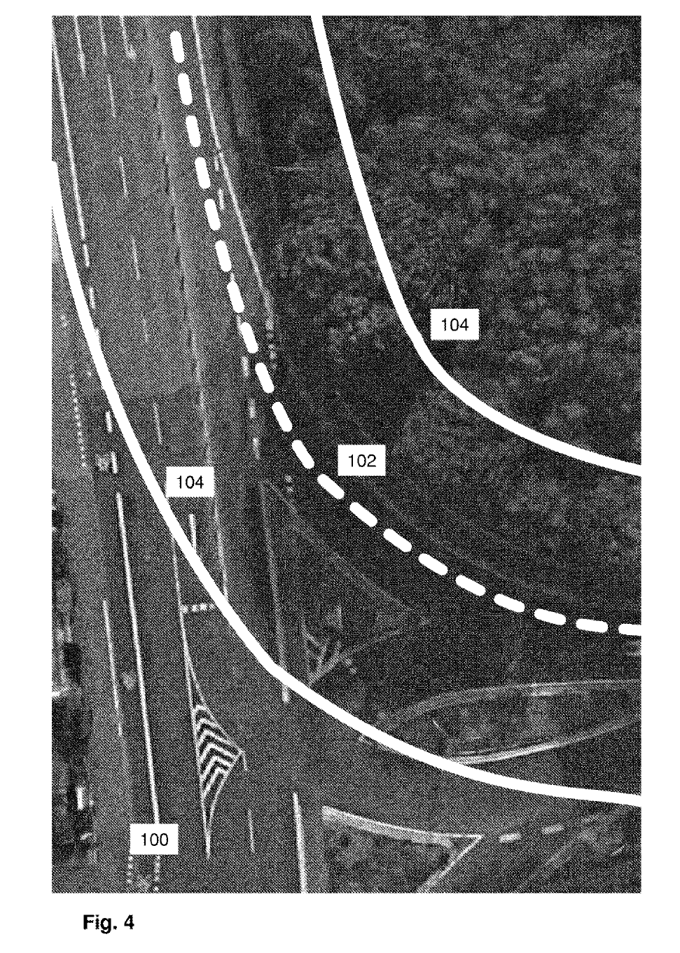

FIG. 1 shows a first exemplary illustration of an aerial image 100 and of a trajectory 102 recorded by a vehicle, which have been received by a system according to the invention. The trajectory 102 is illustrated without scale and is illustrated on a white background for reasons of better visibility. The system carries out method steps in order to make the trajectory correspond to a road depicted in the aerial image. For this purpose, initial positioning can be carried out using absolute coordinates, for example from a satellite navigation system, thus simplifying and accelerating the process of finding a road with a course matching the trajectory. The method steps comprise, inter alia, linear extension and compression operations, at least in pieces, but also rotation operations. The dashed oval in the upper half of the image indicates the image section that is illustrated in an enlarged form in FIG. 4.

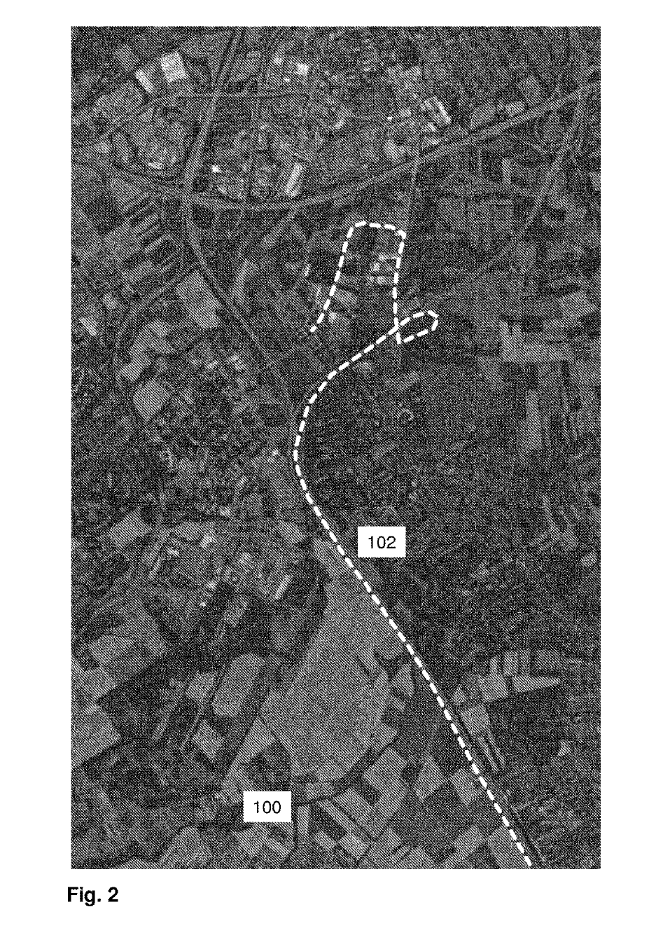

FIG. 2 shows an illustration of the aerial image from FIG. 1, in which the trajectory 102 has been made to correspond to a road that can be identified in the aerial image 100. In comparison with FIG. 1, it can be clearly seen that the trajectory 102 has been enlarged in two dimensions by an extension operation in order to match the course of the road.

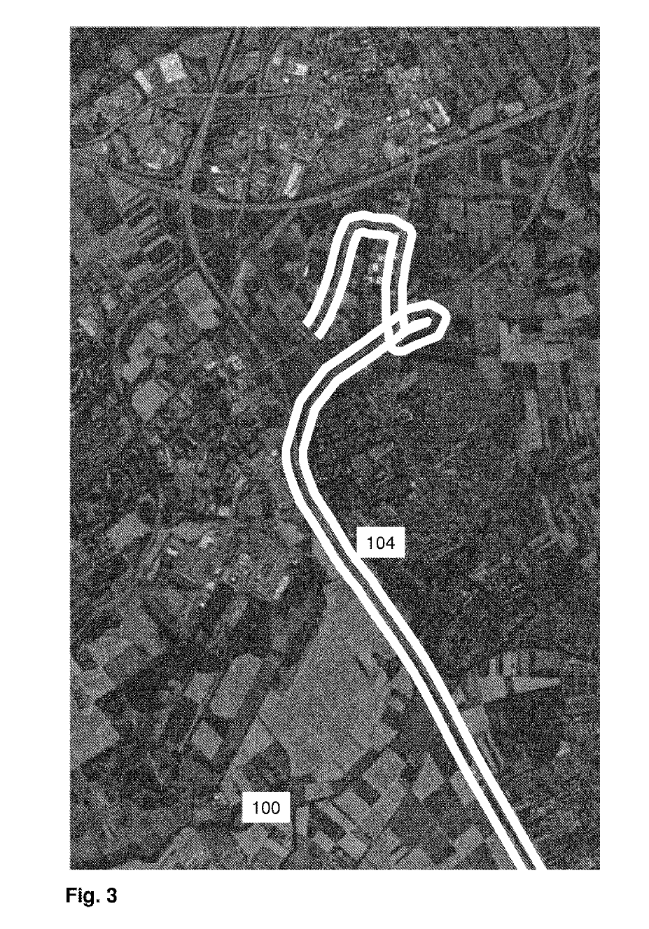

FIG. 3 shows an exemplary illustration of a corridor 104 around the trajectory 102, within which a search is carried out for features of the road. The corridor 104 is represented by the lines which run in a parallel manner and enclose the trajectory 102 (not shown) and the road.

FIG. 4 shows a part of the corridor from FIG. 3 in an enlarged image section. It can be clearly seen that the trajectory 102 runs in a lane of the road. The outer boundaries of the corridor 104 run parallel to the trajectory and enclose large parts of the road. Evaluation of the aerial image for the purpose of identifying features of the road that can be used to position vehicles, for example road markings, is carried out only within the corridor 104, as a result of which the effort for the identification is greatly reduced and the result becomes more reliable because incorrect assignments can be avoided more easily, for example.

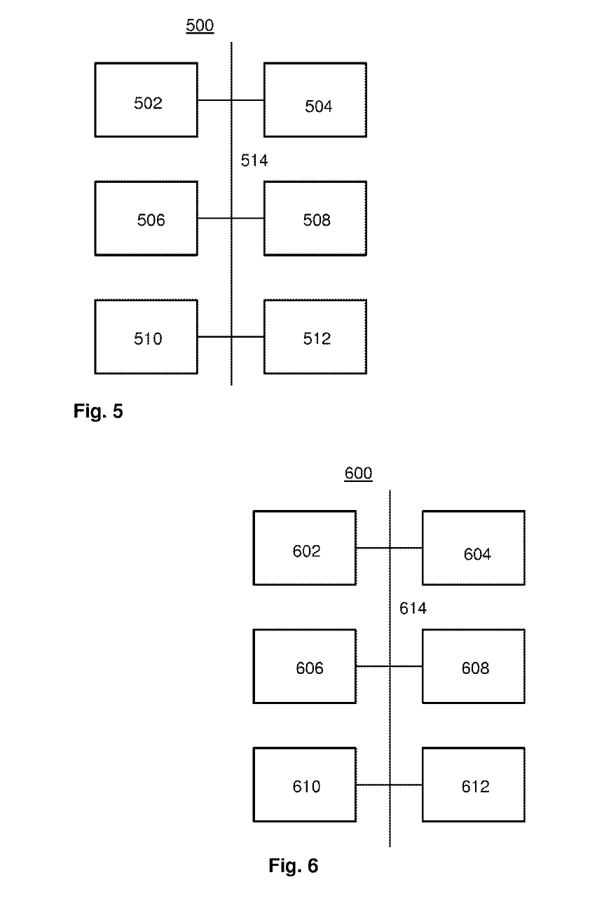

FIG. 5 shows an exemplary block diagram of a part 500 of the system according to the invention. A database 502, a first module 504 for receiving at least one trajectory of a vehicle for the at least one road section and for storing the at least one trajectory in the database and a second module 506 for receiving at least one image that shows at least parts of the at least one road section are communicatively connected to one another via one or more bus systems 514. The one or more bus systems 514 also connect a third module 508 for superimposing the at least one image on the at least one trajectory, a fourth module 510 for analyzing the at least one image in a corridor that extends along the trajectory and encloses the trajectory and for identifying driving-relevant or positioning-relevant features of the road section in the corridor, and a fifth module 512 for generating the digital road model from the driving-relevant or positioning-relevant features that have been identified in the at least one image aligned on the basis of the at least one trajectory and in the corridor enclosing the trajectory to one another and to the first module 504, the second module 506 and/or the database 502.

FIG. 6 shows an exemplary block diagram of a module 600 of the system suitable for performing at least parts of the method according to the invention. The module 600 comprises a microprocessor 602, a RAM 604, a nonvolatile memory 606, one or more interfaces 608 and a database 610 which are communicatively connected to one another via one or more bus systems 612. The nonvolatile memory 606 contains computer program instructions that, when executed by the microprocessor 602 in conjunction with the main memory 604 and possibly with access to further system components, perform at least parts of one or more aspects of the method according to the invention.

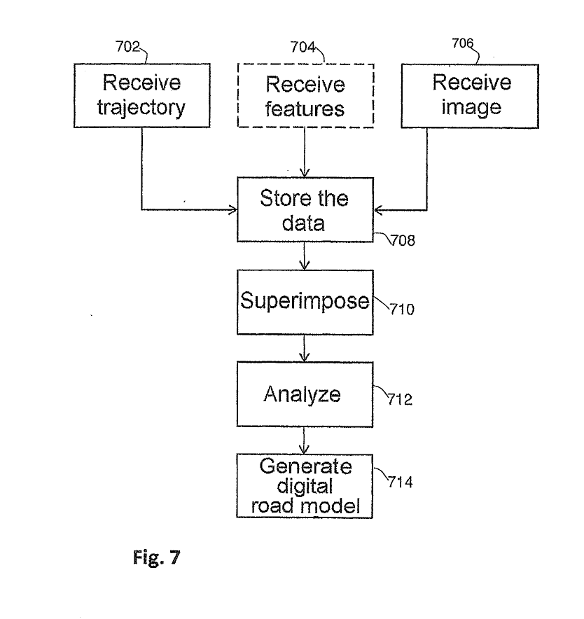

FIG. 7 shows a simplified exemplary flowchart of an aspect of the method according to the invention. The flowchart can in this instance also be regarded as a depiction of functional modules, each module performing applicable parts of the method. In step or module 702, at least one trajectory of a vehicle for the at least one road section is received, and, in step or module 706, at least one image which shows at least parts of the at least one road section and has a perspective which corresponds to an image recorded from an elevated position substantially vertically downward is received. In the optional step or module 704, information relating to driving-relevant features of the road section and relating to respective capture locations or positions is received, and/or an elevation component for at least one part of the road section is received or is retrieved from an external database. In step or module 708, the data are stored and are provided in a retrievable manner for the superimposition carried out in step or module 710. The at least one image is analyzed in a corridor that extends along the trajectory over a first distance transversely with respect to the trajectory and encloses the latter, and driving-relevant or positioning-relevant features of the road section in the corridor are identified in step or module 712. A digital road model is finally generated from the driving-relevant or positioning-relevant features identified in step or module 712 and is retrievably stored in step or module 714.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A method for creating a digital road model for at least one road section, comprising:
receiving at least one trajectory of a vehicle for the at least one road section and storing the least one trajectory in a database outside the vehicle;
receiving at least one image that shows at least parts of the at least one road section, wherein the image has a perspective that corresponds to an image recorded from an elevated position substantially vertically downward and storing the least one image in the database;
superimposing the at least one image on the at least one trajectory such that the at least one trajectory corresponds to a course of a road in the at least one image;
analyzing the at least one image in a corridor that extends along the trajectory and encloses the trajectory, and identifying driving-relevant or positioning-relevant features of the road section in the corridor; and
generating the digital road model from the driving-relevant or positioning-relevant features identified in the at least one image, aligned on the basis of the at least one trajectory and in the corridor enclosing the trajectory.

10. The method as claimed in claim 9, further comprising:
capturing, by the vehicle, information relating to driving-relevant or positioning-relevant features of the road section; and
receiving information relating to driving-relevant or positioning-relevant features of the road section captured by the vehicle, wherein the features comprise information relating to respective capture locations or positions.

11. The method as claimed in claim 10, wherein the information relating to features of the road section is received in an object-describing vector format.

12. The method as claimed in claim 11, wherein at least one reference point is determined for each feature represented by the object-describing vector format.

13. The method as claimed in claim 9, wherein an elevation component for sections of the digital road model is extracted from data relating to the at least one trajectory, from a topography database or from a digital elevation model.

14. A system for creating a digital road model for at least one road section, comprising:
a database configured to retrievably store trajectories and images;
a first module configured to receive at least one trajectory of a vehicle for the at least one road section and for storing the at least one trajectory in the database;
a second module configured to receive at least one image that shows at least parts of the at least one road section, wherein the image has a perspective that corresponds to an image recorded from an elevated position substantially vertically downward, and for storing the at least one image in the database;
a third module configured to superimpose the at least one image on the at least one trajectory such that the at least one trajectory corresponds to the course of a road in the at least one image;
a fourth module configured to analyze the at least one image in a corridor that extends along the trajectory and encloses the trajectory, and configured to identify driving-relevant or positioning-relevant features of the road section in the corridor; and
a fifth module configured to generate the digital road model from the driving-relevant or positioning-relevant features that have been identified in the at least one image, aligned on the basis of the at least one trajectory and in the corridor enclosing the trajectory.

15. The system as claimed in claim 14, further comprising:
a sixth module configured to receive information relating to driving-relevant or positioning-relevant features of the road section captured by the vehicle, wherein the features comprise information relating to respective capture locations or positions.

16. The system as claimed in claim 14, further comprising:
a seventh module for extracting an elevation component for sections of the digital road model from data relating to the at least one trajectory, from a topography database or from a digital elevation module and for accordingly supplementing the sections of the digital road model with the elevation component.
